(19) United States
(12) Patent Application Publication
(10) Pub. No.: US 2012/0320260 A1
(43) Pub. Date: Dec. 20, 2012

(54) Image Sensor and Method for Packaging Same

(75) Inventors: Jongsoo Ha, Suwon (KR); ChungSeok Lee, Suwon (KR)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/525,279

(22) Filed: Jun. 16, 2012

(30) Foreign Application Priority Data
Jun. 17, 2011 (CN) 201110163682.4

(51) Int. Cl. H04N 5/225; H04N 5/33

(52) U.S. Cl. 348/360; 348/E05.09; 348/E05.026

(57) ABSTRACT

An image sensor includes a ceramic base with a cavity therein, the ceramic base including a sidewall forming a conductive layer embedded therein. A protrusion extends from the sidewall toward the center of the cavity. An infrared filter is mounted on the upper surface of the protrusion with a most upper surface of the infrared filter not higher than the upper surface of the ceramic base; and an image unit is mounted in a recess of a bottom plate assembled with a lower surface of the ceramic base.

### FIELD OF THE INVENTION

The present disclosure generally relates to the art of image sensors and, more particularly, to an image sensor with a ceramic package.

### DESCRIPTION OF RELATED ARTS

Ceramic is a widely used packaging material for packaging electrical components by virtue of its high thermal conduction and excellent insulating property. With the developments of mobile phones, digital cameras, and computers, the demand for ceramic packages is more and more desired. Further, in order to satisfy the trends of reducing the volume of electrical components, ceramic packages are designed to have smaller and smaller sizes.

Digital products, such as digital cameras, generally use a plurality of ceramic packages. Typically, a component with a ceramic package includes a ceramic base assembled with image sensors, IR filters on upper and lower surfaces thereof, which increases the height of the component, and complicates the manufacturing process.

So, it is necessary to provide a new image sensor for solving the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and exploded view of an image sensor in accordance with an exemplary embodiment of the present disclosure.

FIG. 2 is a cross-sectional view of the image sensor in FIG. 1.

FIG. 3 is an enlarged view of the Part A in FIG. 2.

FIGS. 4-9 are illustrations of the processes for packaging the image sensor.

### DETAILED DESCRIPTION OF AN EXEMPLARY EMBODIMENT

Reference will now be made to describe an exemplary embodiment of the present disclosure in detail.

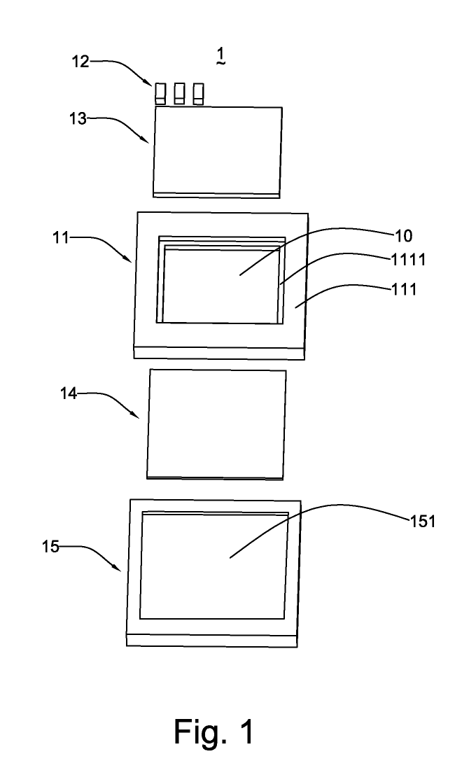

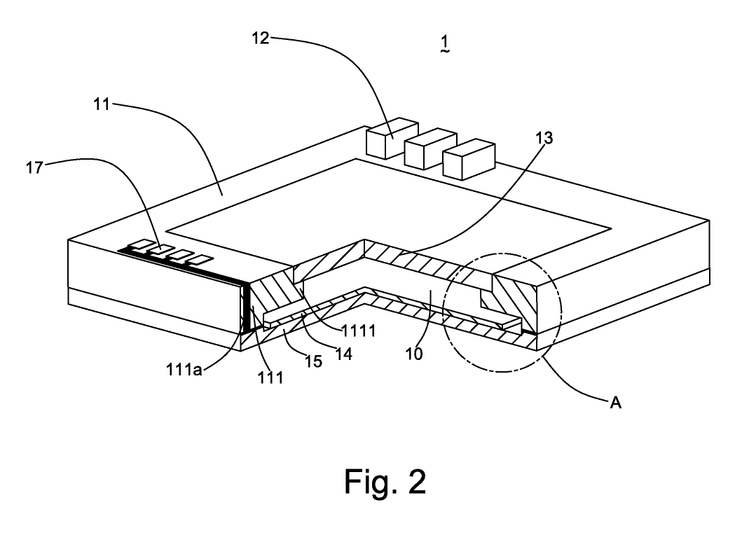

Referring to FIG. 1, which is an isometric and exploded view of an image sensor 1 in accordance with an exemplary embodiment of the present disclosure, the image sensor 1 includes a ceramic base 11 having a cavity 10 therein, an electrical component 12 positioned on an upper surface of the ceramic base 11, an infrared (IR) filter 13 fixed on the ceramic base 11, a bottom plate 15, and an image unit 14 received in the bottom plate 15. The ceramic base 11 includes a sidewall 111 surrounding the cavity 10. The sidewall 111 includes a conductive layer 111a embedded therein (referring to FIG. 2). Further, the sidewall 111 includes a protrusion 1111 extending toward the center of the cavity 10. The IR filter 13 is carried by the upper surface of the protrusion 1111 with the most upper surface thereof not higher than the upper surface of the ceramic base 11. The bottom plate 15 defines a recess 151 and the image unit 14 is accommodated in the recess 151. The bottom plate 15 is assembled with the lower surface of the ceramic base 11 by glue or other adhesion means.

Referring to FIG. 2, the electrical component 12 may comprise multi-layer ceramic capacitors (MLCC), inductors, or resistances. A connector 17 is arranged on the upper surface of the ceramic base 11 for electrically connecting to an external circuit. The connector 17 is electrically connected to the conductive layer 111a embedded in the sidewall 111 of the ceramic base 11. The bottom plate 15 is assembled with the lower surface of the ceramic base 11 by glue or other adhesion means, such as anisotropic conductive film, anisotropic conductive plastic, or non-conductive paste material combined with conductive particles.

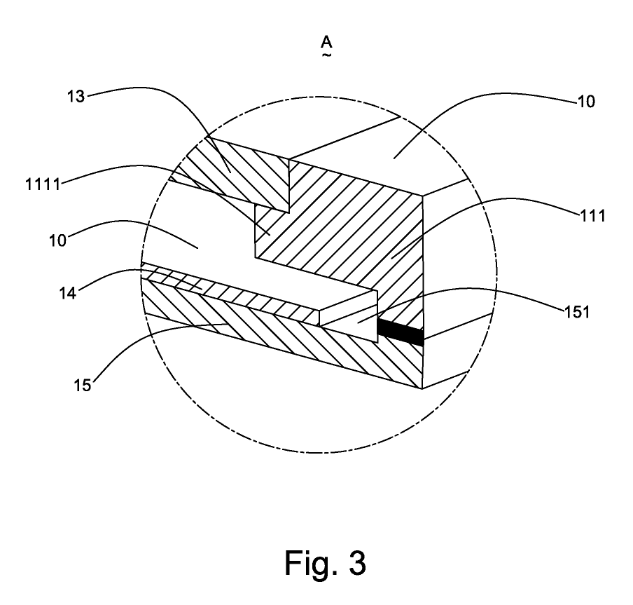

Referring to FIG. 3, which is an enlarged view of Part A in FIG. 2, the assembly relationship between the IR filter 13, image unit 14, the bottom plate 15, and the protrusion 1111 is clearly illustrated.

Referring to FIG. 9, when the image unit 14 is positioned in the recess 151 of the bottom plate 15, a leading wire is provided with one end electrically connected to the image unit 14 and another end electrically connected to the glue between the bottom plate 15 and the ceramic base 11 and then electrically connected to the conductive layer 111a embedded in the sidewall 111 of the ceramic base 11. Thus, the image unit 14 is electrically connected to the connector 17 on the upper surface of the ceramic base 11.

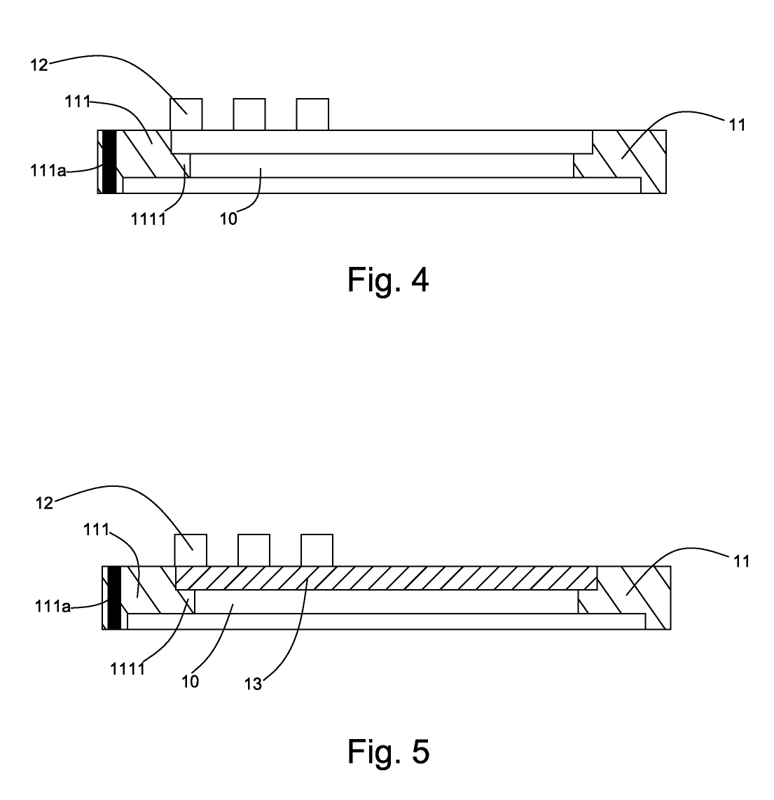

FIGS. 4-9 illustrate the processes of packaging the image sensor. The processes comprise the steps as follows:

Step 1, as shown in FIG. 4: Provide an electrical component 12 and a ceramic base 11 with a cavity 10 therein. The ceramic base 11 is provided with a sidewall 111 surrounding the cavity 10 and including a conductive layer 111a embedded therein. The sidewall 111 defines a protrusion 1111 extending toward the center of the cavity 10. The electrical component 12 is positioned on the upper surface of the ceramic base 11.

Step 2, as shown in FIG. 5: Provide an IR filter 13 and position the IR filter 13 on the upper surface of the protrusion 1111.

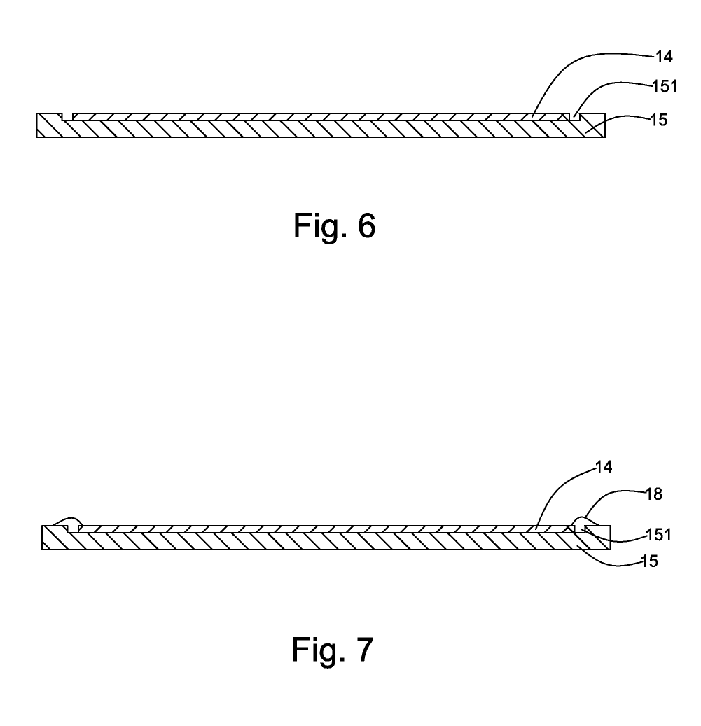

Step 3, as shown in FIG. 6: Provide an image unit 14 and a bottom plate 15 defining a recess 151, and then fix the image unit 14 on the recess 151 of the bottom plate 15.

Step 4, as shown in FIG. 7: Provide a leading wire 18 with one end electrically connected to the image unit 14

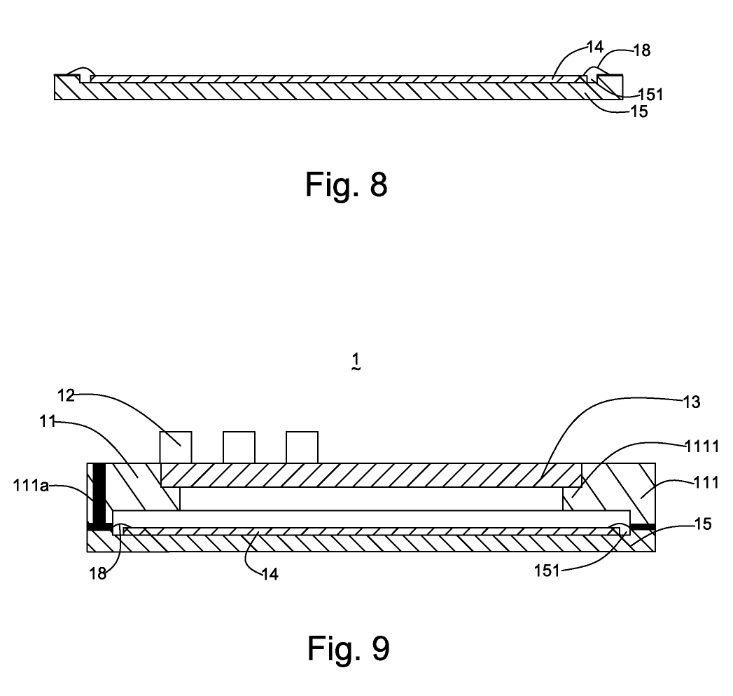

Step 5, as shown in FIG. 8: Provide glue on the bottom plate 15 and then fix the leading wire 18 with the glue. The glue is arranged on the part where the ceramic base 11 is ready to be assembled with.

Step 6, as shown in FIG. 9: Assemble the bottom plate with the image unit 14 to the ceramic base 11 by the glue.

While assembled, the image unit 14 is electrically connected to the leading wire 18, and then to the glue that is electrically connected to the conductive layer 111a in the sidewall, and finally electrically connected to the connector 13.

In Step 1, referring to FIG. 4, the electrical component 12 is mounted on the upper surface of the ceramic base 11 by Surface Mounting Technology (SMT). In Step 2, referring to FIG. 5, the IR filter 13 is positioned on the protrusion 1111 by UV bonding. In Step 3, referring to FIG.

6, the image unit 14 is positioned in the recess 151 of the bottom plate 15 by die bonding.

The present disclosure provides an image sensor with electrical component positioned on upper surface of the ceramic base by SMT, which enlarges the volume of the cavity. The IR filter and the image unit are fixed inside of the ceramic base for reducing the size of the ceramic package.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. An image sensor, comprising:
a ceramic base with a cavity therein, the ceramic base including a sidewall surrounding the cavity and forming a conductive layer embedded therein;
a protrusion extending from the sidewall toward the center of the cavity;
an electrical component positioned on the upper surface of the ceramic base;
an infrared filter mounted on the upper surface of the protrusion with a most upper surface of the infrared filter not higher than the upper surface of the ceramic base;
a bottom plate attached to the lower surface of the ceramic base, the bottom plate including a recess;
an image unit accommodated in the recess and electrically connected to the conductive layer embedded in the sidewall of the ceramic base by a leading wire.

2. The image sensor as described in claim 1, wherein the electrical component comprises multi-layer ceramic capacitor, inductor, or resistance.

3. The image sensor as described in claim 1, wherein the bottom plate is attached to the lower surface of the ceramic base by conductive glue

4. The image sensor as described in claim 3, wherein the glue is made from anisotropic conductive film, anisotropic conductive plastic, or non-conductive paste material combined with conductive particles.

5. The image sensor as described in claim 1 further comprising a connector positioned on the upper surface of the ceramic base for electrically connecting to the image unit via the conductive layer embedded in the sidewall of the ceramic base and the leading wire.

6. A packaging method for packaging the image sensor as described in claim 1, comprising the steps of:
providing an electrical component and a ceramic base with a cavity therein, the ceramic base including a sidewall surrounding the cavity and forming a conductive layer embedded therein, the sidewall defining a protrusion extending toward the center of the cavity, the electrical component being positioned on the upper surface of the ceramic base;
providing an infrared filter and positioning the infrared filter on the upper surface of the protrusion;
providing an image unit and an bottom plate, the bottom plate defining a recess, and then fixing the image unit in the recess;
providing a leading wire with one end electrically connected to the image unit;
providing glue on the bottom plate and then fix the leading wire with the glue, the glue being arranged on the part where the ceramic base is ready to be assembled with;
assembling the bottom plate to the ceramic base by the glue.

7. The packaging method as described in claim 6, wherein the electrical component is mounted on the upper surface of the ceramic base by surface mounting technology.

8. The packaging method as described in claim 6, wherein the infrared filter is positioned on the upper surface of the protrusion by UV bonding.

9. The packaging method as described in claim 6, wherein the image unit is positioned in the recess by die bonding.
